(19) United States
(12) Patent Application Publication
(10) Pub. No.: US 2020/0086664 A1
(43) Pub. Date: Mar. 19, 2020

(54) INKJET PRINTER WITH VACUUM SYSTEM

(71) Applicant: AGFA NV, Mortsel (BE)

(72) Inventors: Mark VERHEIJEN, Mortsel (BE); Koen DAEMS, Mortsel (BE)

(21) Appl. No.: 16/471,588

(22) PCT Filed: Dec. 4, 2017
(86) PCT No.: PCT/EP2017/081360

§ 371 Date: Jun. 20, 2019

(30) Foreign Application Priority Data
Dec. 22, 2016 (EP) 16206120.4

(51) Int. Cl. B41J 11/00; B41J 13/22; B65H 29/24; B65H 3/12; B65H 11/00; B41J 3/407

(52) U.S. Cl. CPC B41J 11/0085; B41J 13/226; B65H 29/242; B41J 11/007; B65H 11/005; B41J 3/4078; B65H 3/124

(57) ABSTRACT

An inkjet printer includes an air-permeable media-support-layer positioned on top of a vacuum table. The vacuum table includes a plurality of cavity rooms, connected to a vacuum source, for forming a plurality of vacuum zones on the air-permeable media-support-layer; each cavity room from the plurality of cavity rooms is closed by an air-permeable part from the air-permeable media-support-layer for forming a vacuum zone from the plurality of vacuum zones. Each cavity room from the plurality of cavity rooms includes a) a space formed by a set of walls; and b) a bottom layer including a set of air-channels; wherein a ratio of width to length from the minimum bounding box of the area formed by the set of walls is between 1:1 and 2:5.

### CROSS REFERENCE TO RELATED APPLICATIONS

This application is a 371 National Stage Application of PCT/EP2017/081360, filed Dec. 4, 2017. This application claims the benefit of European Application No. 16206120.4, filed Dec. 22, 2016, which is incorporated by reference herein in its entirety.

### BACKGROUND OF THE INVENTION

### 1. Field of the Invention

The present invention relates to an inkjet printer comprising a vacuum system for holding down print-media on a flat surface while printing on the print-media.

### 2. Description of the Related Art

Inkjet printers with a vacuum system, such as a vacuum belt for transporting print-media underneath a printhead, are well known. Such inkjet printers currently are adapted for sign & display market with small sized substrates to much larger substrates or multiple substrates, printed at the same time, for industrial market; and special print-media such as manufacturing methods for glass, laminate floorings, carpets, textiles comprising inkjet printing methods. An example of such inkjet printer is Agfa Graphics™:Jeti Tauro.

One of the issues with inkjet printers from the state-of-the-art, which comprise a vacuum system for holding down a print-media, is the difficulty to handle, to transport, to print on all kind of print-media. The versatility is rather low and only a subset of print-media-types can be handled and/or transported by these inkjet printers. Several methods to enlarge the versatility of an inkjet printer with a vacuum system are known, for example by providing an optimized air-channel design from the media-support-layer to a vacuum pump from the vacuum system. For example WO2016071122 (AGFA GRAPHICS) discloses a vacuum system in paragraph [0135] wherein the plurality of holes in a porous conveyor belt, as air-permeable media-support-layer, is optimized to a certain diameter for the disclosed vacuum-system. Such holes in an air-permeable media-support-layer are also called air-channels.

The size of print-media becomes larger and larger so to hold down this kind of print-media's:
a larger media-support-layer is needed; and
higher power is needed for one or more vacuum pumps, connected to the vacuum system; and/or
more vacuum pumps, connected to the vacuum system, are needed. Inkjet printers for large print-media exist already several years such as the INCA™ Onset S40 or Agfa Graphics™:M-PRESS TIGER which are both capable to handle very large print-media for sign& display print jobs. Another example is the HYMMEN™ JPT-L for printing furniture panels, doors, laminate, REGGIANI MACHINE™ ReNOIR for printing on fabric web with a maximum web-width up to 3.40 m or DIEFFENBACHER™ Colorizer for furniture production with formats up to 2.070 mm×3.600 mm.

In addition, some print-media-types, especially when they have a large size, are difficult to hold-down against the air-permeable media-support-layer of the vacuum system. This may cause in curling, crinkling of print-media's that effects the print-quality badly. In the state-of-the-art inkjet printers tries to solve this by applying higher vacuum power on the media-support-layer layer by applying one or more stronger vacuum pumps, connected to the vacuum system. An example of such difficult-to-be-handled print-media is rigid multi-layered print-media due to inside tensions of this print-media-type, which has a rather high inside tensions and this may cause suddenly warping up of the print-media while printing and/or drying the ink. Therefore, there is a need of inkjet printers that bullet proof avoids collisions against the dryer and/or print head by having a vacuum system that can hold-down such print-media's. Applying a stronger vacuum pump for the vacuum system is not always an ideal solution for example it can cause the deformation of print-media by the suction force. In addition, a stronger vacuum pump for the vacuum system makes the manufacturing cost of an inkjet printer much higher and raises the energy consumption of the inkjet printer. With the wording, “stronger vacuum pump”, it is meant to be a vacuum pump with a higher vacuum set point so the suction force becomes stronger at the vacuum table.

However, not only a larger media-support-layer is needed also a higher productivity of the inkjet printer is of a big importance due to economically reasons. Several methods of handling multiple print-media's at the same time on a large media-support-layer are already known. For example EP2508347 (THIEME GMBH & CO. KG) discloses a method of handling multiple print-media's by detecting them on the platen, which is a media-support-layer, by detecting the positions of the multiple print-media's. The total area of the multiple print-media's that have to be hold-down against the air-permeable media-support-layer may ask for stronger vacuum pumps as stated-above but causes also a bigger loss of vacuum power at the unchoked holes in the air-permeable media-support-layer which are the holes not covered by one of the multiple print-media's.

The loss of vacuum power occurs also on a large air-permeable media-support-layer where on a small print-media (300) has to be hold-down, because several holes in the air-permeable media-support-layer becomes unused holes thus unchoked holes, also called not-smothered holes.

To minimize or prevent this loss of vacuum power, it is a known method by applying tape on the unused holes from the air-permeable media-support-layer or less efficient by applying stronger vacuum power on the air-permeable media-support-layer. The tape is a time-consuming production method for the printer operator that has to repeat it every time another sized print-media is provided on the air-permeable media-support-layer. A strong vacuum power asks for a higher energy-consumption or a more expensive vacuum pump, which may apply a higher vacuum power on the air-permeable media-support-layer.

Another known method of choking unused holes from the air-permeable media-support-layer for preventing the loss of vacuum power is applying a system of separate vacuum chambers in the vacuum system, which can be controlled to apply or not apply a vacuum power in a vacuum zone on the air-permeable media-support-layer. Examples of such method in a vacuum system of an inkjet printer is disclosed in US20110292145 (XEROX CORPORATION) or in EP2868604 (AGFA GRAPHICS) wherein a movable wall controls the size of vacuum zones on the air-permeable media-support-layer.

WO2015136137 (LATORRE JESUS FRANCISCO BARBERAN) discloses, for the problem of losing vacuum power at unused holes in the air-permeable media-support-layer, a vacuum system with an actuation system to control a drawer connected to the holes of the air-permeable media-support-layer by opening the hole or not. This makes the inkjet printer, especially the vacuum table expensive for manufacturing the inkjet printer and by comprising an extra motor to drive the shaft transmission also an extra energy consumption.

Another problem that occurs at the unused holes on the air-permeable media-support-layer is that the vacuum power at these holes influences badly the ink trajectory from print head to print-media while printing, especially when a high vacuum power on the air-permeable media-support-layer is applied for example for preventing curling of the print-media. Normally the ink trajectory is more or less straight, perpendicular from the printhead to the print-media but by the suction, this trajectory can deviate so the print quality is bad due to wrong ink drop positioning on the print-media.

Another way is the closing of the unused holes by applying a diaphragm inside the vacuum table per hole. These diaphragms can be controlled, for example by a valve, individually to have an open hole, semi-open hole or closed hole so the loss of vacuum can be controlled. The reliability of such a system is unsure and the manufacturing cost is too high.

It is also known that these unused holes receive by the suction power: ink mist, paper dust, media fibres and/or ink debris such as cured ink. These contaminate the unused holes and the inner-side of the air-channels and vacuum chamber(s) from the vacuum system. In the state-of-the-art an air-filter and/or coalescence filter is connected to the vacuum pump connector to split liquid and air from the contamination in the vacuum pump connector but the contaminations remain in the air-channels which are difficult to clean, for example by time-consuming re-perforation of the holes in the air-permeable media-support-layer with a toothpick or other sharp pike.

To address the problem of an inkjet printer with a vacuum system that can handle large print-media's and small print-media's/multiple small print-media's and the possible loss of vacuum power at unused air-channels at the air-permeable media-support-layer a solution is needed without a higher manufacturing cost of the inkjet printer and higher production cost of printed print-media. This solution should become very effective if also, contamination in inner-side of the vacuum system is minimized and the suction power on the air-permeable media-support-layer does not influence badly the ink trajectory from print head to print-media and the versatility to handle print-media is enlarged.

### SUMMARY OF THE INVENTION

In order to overcome the problems described above, preferred embodiments of the present invention have been realized with an inkjet printer as defined below.

The present invention is an inkjet printer comprising an air-permeable media-support-layer (100), positioned on top of a vacuum table. The air-permeable media-support-layer (100) gives support to carry print-media, also called ink receiver, that shall be printed by the inkjet printer. The vacuum table underneath the air-permeable media-support-layer (100) provides extra support to carry the print-media.

The air-permeable media-support-layer (100) is preferably flat and more preferably has a flatness less than 300 μm. The flatness on the top of the support layer is crucial to have good print quality on an ink receiver which is supported on the support layer because it influences the throw distance, which is the distance of jetting a droplet from printhead to ink receiver. The maximum height distance in the areas on the top of the air-permeable media-support-layer (100), which do not comprise apertures and notches, relative to a plane defined by three areas on the top of the air-permeable media-support-layer (100), which do not comprising apertures and notches, defines the flatness of an air-permeable media-support-layer (100). A flexible ink receiver, supported by these areas on the top of the air-permeable media-support-layer (100), which do not comprising apertures and notches shall than have the same flatness as the air-permeable media-support-layer (100). To measure the flatness of an air-permeable media-support-layer (100), several flatness measurement tools are available in the state-of-the art, for example the measurement tool disclosed in U.S. Pat. No. 6,497,047 (FUJIKOSHI KIKAI KOGYO KK). The flatness of an air-permeable media-support-layer (100) can also be measured by surface profilometers such as the KLA-Tencor™ series of bench top stylus and optical surface profilometers.

The inkjet printer may be a flatbed inkjet printer, preferably a large-format flatbed inkjet printer, wherein the air-permeable media-support-layer (100) a flat rigid layer wherein the flatbed is formed by the air-permeable media-support-layer (100) and the vacuum table. The print-media (300) is positioned on the flatbed and hold down by vacuum power for printing such as for example on the flatbed of the Jeti Mira™, manufactured by Agfa Graphics™ which is a typically flatbed inkjet printer.

Alternatively, the inkjet printer may comprise a porous conveyor belt, as air-permeable media-support-layer (100), whereon print-media (300) is carried and transported, and hold down by vacuum power for printing. Underneath the porous conveyor belt is a vacuum table positioned. Such porous conveyor belt is also called a vacuum belt. An example of such inkjet printer is the Jeti Tauro™, manufactured by Agfa Graphics™.

To form the vacuum at the holes, also called air-channels, on the air-permeable media-support-layer (100), there is a vacuum source or pump, also called vacuum pump, operatively connected to the vacuum table. In operation, air is evacuated from these holes, through a network of air-channels inside the vacuum table under negative pressure from a vacuum source, preferably a pump to apply suction to print-media (300) supported on the air-permeable media-support-layer (100). These air-channels, also called apertures, may be circular, elliptical, square or rectangular shaped, as cross-section parallel to the air-permeable media-support-layer (100).

The present invention comprises in the vacuum table a plurality of cavity rooms, connected to one or more vacuum sources, such as a vacuum pump, for forming a plurality of vacuum zones on the air-permeable media-support-layer (100), such as a porous conveyor belt. The air-permeability of the media-support-layer is caused by air-channels in the layer, which are connected to a vacuum pump of the vacuum system in the presented inkjet printer. The plurality of cavity rooms depends on the area of the vacuum table and the area of each cavity room (200). A vacuum zone from the plurality of vacuum zones may overlap another vacuum zone from the plurality of vacuum zones, but they are both generated by another cavity room (200) from the plurality of cavity rooms.

These cavity rooms are comprised in the top layer of the vacuum table so each cavity room (200) from the plurality of cavity rooms is closed by an air-permeable part from the air-permeable media-support-layer (100). The air-permeable part covers the top of a cavity room (200). The air-permeable part forms on the ink receiver side a vacuum zone from the plurality of vacuum zones by a plurality of air-channels.

A cavity room (200) in the present invention comprises:

a) a space (230), formed by a set of walls (220); and

b) a bottom layer (250) comprising a set of air-channels.

The bottom layer (250) may have one or more air-channels, which is/are connected to a vacuum source, such as a vacuum pump.

Therefore, the plurality of air-channels (105) from the air-permeable part are connected via the space (230) and then via the set of air-channels (255) to a vacuum source, such as a vacuum pump. The ‘plurality of air-channels’ is in here the air-channels from the air-permeable part, the ‘set of air-channels’ is in here the air-channels from the bottom layer.

It is found that by a vacuum table which comprises such a plurality of cavity rooms as in the present invention that the edges from print-media (300) is better hold down so curling at the edges from print-media (300) is prevented. A curl at an edge of a print-media (300) may touch a printhead while printing which should be avoided.

The air-permeable part is supported by the set of walls (220) so it closes the cavity room (200) as an air-permeable cover or air-permeable lid.

The set of air-channels (255) comprised in the bottom layer (250) is sometimes further named as a set of cavity-holes or a set of cavity-air-channels.

The set of walls (220) are preferably upstanding walls, upright walls or angled towards the bottom layer (250) between 45 degrees and 135 degrees, more preferably angled towards the bottom layer (250) between 70 degrees and 100 degrees, most preferably angled towards the bottom layer (250) between 85 degrees and 95 degrees.

These set of walls (220) are forming an area having any shape, which is preferably substantially polygonal, and more preferably substantially convex polygonal and most preferably substantially regular convex polygonal or the set of walls (220) are forming an area having a polygonal shape. Alternatively, the set of walls (220) are forming an area having a substantially circular or substantially elliptical shape or an elliptical shape. A wall may have small corrugations or small projections; so not a flat wall, but the shape is substantially: polygonal or convex polygonal or regular convex polygonal, circular, or elliptical.

It is found that this shape have to be compact and not elongated for an optimal vacuum system with minimal vacuum loss so in a preferred embodiment is ratio of width to height from the minimum bounding box of the area formed by the set of walls (220) is between 1:1 and 2:5, more preferably between 1:1 and 1:2. It is clear and has to be interpreted as such that this area is substantially parallel, preferably parallel, to the vacuum table. The width of a minimum bounding box is smaller or equal than the height of the minimum bounding box. The terms width and height are to be interpreted here as in a two dimensional plane parallel to the transport surface if it should be defined in three dimensional space: it is found that this shape have to be compact and not elongated for an optimal vacuum system with minimal vacuum loss so in a preferred embodiment is ratio of width to length from the minimum bounding box of the area formed by the set of walls (220) is between 1:1 and 2:5, more preferably between 1:1 and 1:2.

It is found that if elongated shapes are used the vacuum power is less power-full at the front and back of the elongated cavity hole so more vacuum power is needed, for example by applying a stronger vacuum source, which should be avoided for economically reasons, as stated above. It is also found that a compact shape gives a better hold-down at the edges of print-media (300) on the air-permeable media-support-layer. In geometry, the minimum or smallest bounding or enclosing box for a point set (S) or a certain area in 2 dimensions is the box with the smallest measure (area) within which all the points or the certain area lie.

The air-permeable part is in the present invention in contact with the set of walls (220) and forms a top layer on the cavity room, as a covering of the cavity room (200).

In a preferred embodiment is the volume of the space (230) between 1 mm³ and 8000000 mm³, more preferably between 1 mm³ and 2000000 mm³. This preferred limitation of the volume is together with the compact shape, which is meant not elongated, of interest for an optimal vacuum system with minimal vacuum loss and a vacuum system wherein no big vacuum pumps are needed when the air-permeable media-support-layer (100) is manufactured for large-sized print-media.

The depth of the cavity room (200) is preferably between 0.001 mm and 200 mm, more preferably between 0.01 mm and 100 mm and most preferably between 0.1 mm and 10 mm.

The width and/or height of the vacuum table is preferably from 1.0 m until 10 m. The larger the width and/or height, the larger print-media (300) may be supported by the inkjet printer which is an economical benefit. This gives a large area so normally stronger vacuum powers which is not needed for the present invention. The area of the vacuum table is preferably between 1 m² and 100 m².

In a preferred embodiment each air-permeable part, that closes a cavity room (200) from the plurality of cavity rooms, comprises a plurality of air-channels, which are manufactured so the sum of areas from the plurality of air-channels (105) is equal or bigger than the sum of areas from the set of air-channels (255) from the bottom layer, comprised in the cavity room (200).

The area of an air-channel is the area formed by a cross-section parallel to the layer wherein it is comprised and/or perpendicular to the air-flow direction in the air-channel. If for example the inner wall of an air-channel is bent inwardly, it is known in the science of fluid-dynamics that the area of a cross-section, parallel to the layer wherein it is comprised and/or perpendicular to the air-flow direction in the air-channel, which gives the smallest area is called in general ‘the area of an air-channel’.

It is known that the area of the air-channels define the flow through the air-channels but in the present invention there is a cascade of air-channels; such as orifices or holes:

a) an air-channel in the air-permeable part; and
b) an air-channel in the bottom layer (250) from the cavity room (200).

It is especially this cascading of air-channels, such as orifices or holes, which makes the present invention a solution for the above-described problems.

To distribute the flow evenly over the cavity room (200) the flow must be choked on the air-channels from the air-permeable part that allow flow to the cavity room, thus the unused holes. It is found that therefore the sum of areas from the plurality of air-channels (105) have to be equal or bigger than the sum of areas from the set of air-channels (255) from the bottom layer, comprised in the cavity room (200). With an unused hole, it is meant that a print-media (300) on the air-permeable media-surface-layer does not cover it.

The set of air-channels (255) from the bottom layer (250) may be one or more air-channels, such as holes or orifices. The area of an air-channel, such as holes or orifices, at the side of the bottom layer (250) is preferably between 0.25 mm² and 100 mm², more preferably between 1 mm² and 64 mm² and most preferably between 1.44 mm² and 49 mm².

The plurality of air-channels (105) from the air-permeable part is more than one air-channels, such as holes or orifices. A plurality of air-channels (105) in the air-permeable part is needed to get a broader suction area at the air-permeable part and preferably, the position is equally distributed in the air-permeable part so a print-media (300) can be attached ‘anywhere’ on the air-permeable part and not on one specific suction area. The shape of these air-channels, area of these air-channels and the area of the air-permeable part defines the maximum number of air-channels.

The area of an air-channel (105), such as holes or orifices, at the side of the air-permeable part is preferably between 0.25 mm² and 100 mm², more preferably between 1 mm² and 36 mm² and most preferably between 1.44 mm² and 16 mm². If the area is too big, it is possible that by the suction force the print-media (300) is deformed, especially crease-sensitive; brittle; heat-sensitive or edge-curl sensitive print-receivers which becomes visible in printed results and influences the print quality badly.

The flow through an orifice can be described by the following formula (I-a):

Q=a·d²·d·\sqrt{ΔP}

wherein a=a constant, d=diameter of the orifice, ΔP pressure drop over the orifice and Q the flow through the orifice. The orifices in the present invention are narrow and have a short length.

The formula may also be written as followed (I-b):

$$Δ P = {( \frac{Q}{a … {d}^{2}} )}^{2}$$

It is found and presumed that the flow over cascading orifices with different diameters can be derived from the following presumed formula (II):

$$Q = a \cdot \sqrt{\frac{Δ P}{( \begin{matrix}1 \\ {d}_{1}^{4}\end{matrix} + \begin{matrix}1 \\ {d}_{2}^{4}\end{matrix} + \begin{matrix}1 \\ {d}_{3}^{4}\end{matrix} + … + \begin{matrix}1 \\ {d}_{n}^{4}\end{matrix} )}}$$

wherein a=a constant, d₁ to dₙ diameter of cascaded orifice, n=the amount of orifices in the cascade, ΔP pressure drop over the cascaded orifices and Q the flow through the cascaded orifices.

The flow through open orifices in a layer, such as the air-permeable part, can be calculated using an equivalent virtual hole derived and based on Bernouilli's law with the following presumed formula (III):

D=d·\sqrt{n}

wherein D=diameter of the equivalent virtual hole and n=the amount of open orifices in the layer.

This formula III is an example how to calculate the equivalent diameter from a set of air-channels (N) in a layer, such as the bottom layer (250) in the present invention or the air-permeable part. In this formula III the diameters of each circular hole is the same, so derived from the law of Bernouilli, the formula III is found). It is known in the state-of-the art that an equivalent diameter of a set of air-channels from a layer can also be calculated for a plurality of non-circular shaped air-channels, even they are not uniform or not equally shaped or not equally sized.

This preferred embodiment is even more preferred when the sum of areas from the set of air-channels (255) from the bottom layer, comprised in the cavity room, is smaller than the sum of areas of all air-channels, such as conduits, which connects the set of air-channels, comprised in the cavity room, with the vacuum source, such as a vacuum pump.

Further, in the description, it shall be shown that applying the formulas I-a, I-b, II, III explains the present invention as a solution of the vacuum loss at the unused air-channels in the air-permeable part by the present invention with cascaded orifices.

It is found, as disclosed in the examples, if the plurality of air-channels (105) comprised in the air-permeable part are all holes with a equal circular area and one air-channel, with circular area in the bottom layer (250) of the cavity room (200) underneath the air-permeable part, the ratio between the diameter of a hole in the air-permeable part and the diameter of the hole in the bottom layer (250) is preferably between 0.50 (=±1:2) and 0.166 (=±1:6), more preferably between 0.33 (=±1:3) and 0.2=(±1:5), most preferably between 0.275 (=±11:40) and 0.225=(±9:40).

In a preferred embodiment, whether or not with the previous preferred embodiments, is the ratio between
the equivalent diameter of each air-channel from the plurality of air-channels (105) comprised in the air-permeable part; and
the equivalent diameter of the set of air-channels (255) from the bottom layer
   between 0.50 (=±1:2) and 0.166 (=±1:6), more preferably between 0.33 (=±1:3) and 0.2=(±1:5), most preferably between 0.275 (=±11:40) and 0.225=(±9:40).

### BRIEF DESCRIPTION OF THE DRAWINGS

FIG. 1 is a graph with the values of TABLE 1 according to example 1.

FIG. 2 is a graph with the values of TABLE 2 according to example 2.

FIG. 3 is a graph with the values of TABLE 3 according to example 3.

FIG. 4 is a graph with the values of TABLE 4 according to example 4.

FIG. 5 is a graph with the values of TABLE 5 according to example 5.

FIG. 6 is a figure of cross-section of a cavity room (200) from a preferred embodiment wherein the air flows from the plurality of air-channels (105) in the air-permeable part from an air-permeable media-support-layer (100) via the space (230) in the cavity room (200), via a set of air-channels (255) in the bottom layer (250) of the cavity room (200) to a vacuum source (not visible). The arrow in the figure indicates the air flow. The cavity room (200) is formed by a set of walls (220) and the bottom layer (250).

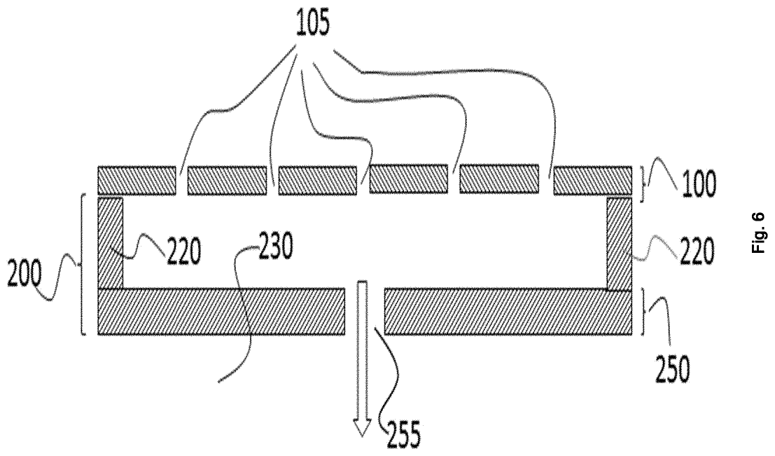

FIG. 7 is a graph with the measured data obtained by TEST 2.1.

FIG. 8 is a graph with the measured data obtained by TEST 2.2.

FIG. 9 is a figure disclosing, similar as in TEST 2.1 and TEST 2.2, a top-view of a part of an air-permeable media-support layer (100) where under a plurality of rhombus shaped cavity rooms (200) is identified by dotted lines to represent the set of walls of each of these cavity rooms (200). The air-permeable media-support layer (100), not visible, is divided in a plurality of vacuum zones with each of them 25 air-channels in the air-permeable part above a cavity room. The bottom in the cavity room comprises one air-channel but is not visible. A print-media (300) is supported on the air-permeable media-support layer (100).

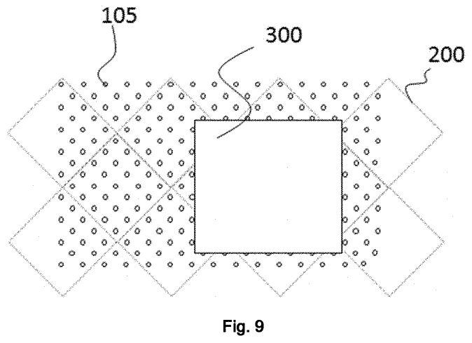

### DETAILED DESCRIPTION OF THE PREFERRED EMBODIMENTS

In a preferred embodiment a wall of the set of walls (220) from a cavity room (200) is angled. The angle

a) between media-transport direction of the air-permeable media-support-layer (100) and a wall from the set of walls (220); or between printhead-movement-direction and
b) the wall is between 5 and 85 degrees, more preferably between 9 and 81 degrees, most preferably between 15 and 75 degrees. The shape of most print-media (300) is rectangular, to achieve a good holding-down over the total area of the print-media, so an angled wall as in this preferred embodiment gives a better holding-down result; especially at the edges of the rectangular shaped print-media. This is especially true if a plurality of cavity rooms comprised in the vacuum table are manufactured as such, most preferably all cavity rooms comprised in the vacuum table are manufactured as such.

The previous preferred embodiment is even more preferred if the shape from the area formed by the set of walls (220) is a rhombus, diamond, rectangle (rotated), parallelogram, trapezium, square (rotated), pentagonal, hexagonal or regular convex polygonal; or substantially rhombus, substantially diamond, substantially rectangle (rotated), substantially parallelogram, substantially trapezium, substantially square (rotated), substantially pentagonal, substantially hexagonal or substantially regular convex polygonal.

In another preferred embodiment, whether or not in combination with the previous embodiments, a cavity room (200) or all cavity rooms from the plurality of cavity rooms in the present invention may comprise an air-permeable ceiling for supporting the air-permeable part even more than only the walls in the cavity room (200). This is to prevent that the air-permeable part sinks in the cavity room, especially when a cavity room (200) has rather a big volume and a big area, for example when the air-permeable media-support-layer (100), such as a vacuum belt, is flexible or not stiff enough. The sinking of a part from the air-permeable media-support-layer (100), as air-permeable part above a cavity room, in a cavity room (200) may deform the print-media, which is supported by this media-support-layer, what results in a bad print quality. Preferably, this ceiling in the cavity room (200) is supported by the set of walls (220).

In a preferred embodiment, whether or not in combination with the previous embodiments, a cavity room (200) or all cavity rooms, comprised in the vacuum table, comprises a filter, such as an air-filter. To have a working embodiment the filter is of course air-permeable. Preferably, the filter distributes, preferably uniform, the air-flow, caused by the vacuum source, inside the cavity room (200) towards the edges of the cavity room (200) and more preferably towards the walls of the cavity room (200). Most preferably, the filter distributes the air-flow towards the corners of the cavity room, for example when the area, formed by the set walls, is substantially polygonal shaped. It is found that such filter towards the edges of the cavity room (200) or the walls of the cavity room (200) or the corners of the cavity room (200) has a better influence for holding down print-media's against the air-permeable media-support-layer (100), probably by a better aero-dynamics. The filter may give a small resistance of the air-flow inside the cavity room (200).

The edge of a wall from the set of walls (220) towards the bottom layer (250) from the cavity room (200) is preferably rounded to have a better air-flow in the cavity room, probably by a better aero-dynamics.

The filter from the previous preferred embodiment may also filter the air from the air-flow, caused by the vacuum source, so contaminations in the air, such as ink-debris or dust, are separated inside this filter, such as a membrane, filter paper, sieve or air-filter. To have a working embodiment the filter is of course air-permeable.

For easy manufacturing, for example by abrading or milling, a vacuum table with the plurality of cavity rooms, the vacuum table, cavity rooms, set of walls (220) and/or bottom layer (250) preferably comprises thermoplastic polymer resin and/or metal, more preferably is an engineering plastic composition or comprises polyethylene terephthalate (PET), polyamide (PA), high-density polyethylene (HDPE), polytetrafluoroethylene (PTFE), polyoxymethylene (POM) and/or polyaryletherketone (PAEK). More information on manufacturing a vacuum table is disclosed in WO2016/071122 (AGFA GRAPHICS).

The vacuum table may comprise a plurality of layers on top of each other which are connected to each other by glue or other means wherein for example:
a layer forms the set of walls (220); and/or
a layer forms a ceiling in a cavity room; and/or
a layer forms the bottom layer (250) in a cavity room (200).

Each layer preferably comprises thermoplastic polymer resin and/or metal, more preferably is an engineering plastic composition, steel or comprises polyethylene terephthalate (PET), polyamide (PA), high-density polyethylene (HDPE), polytetrafluoroethylene (PTFE), polyoxymethylene (POM) and/or polyaryletherketone (PAEK). The ceiling may give a small resistance of the air-flow inside the cavity room.

If the air-permeable media-support-layer (100) is a vacuum belt, it is preferred that each wall from the set of walls (220) at the contact zone with the air-permeable media-support-layer (100) is rounded so a higher lifetime of the vacuum belt is guaranteed. The friction at the set of walls (220) by the vacuum belt when moving can lower this lifetime.

In the present invention, there is a cascade of air-channels, such as orifices or holes, from the air-permeable media-support-layer (100) until the vacuum source, such as a vacuum pump. This cascade can be enlarged by building cavity rooms on top of each other. In a preferred embodiment, whether or not with the previous preferred embodiments, the inkjet printer comprises another cavity room (200) comprising:
another cavity comprised in the vacuum table; and
another bottom layer (250) comprised in the vacuum table which comprises another set of air-channels; and wherein the bottom layer (250) from the cavity room (200) closes the other cavity room (200) to form a top layer on the other cavity. The another cavity is formed by another set of walls (220).

Analogue as in a previous preferred embodiment the sum of areas of the set of air-channels (255) from the bottom-layer of the cavity room (200) is preferably equal or bigger than the sum of areas from the other set of air-channels (255) from the bottom-layer of the other cavity room (200) and on top more preferably the sum of areas from the other set of air-channels (255) from the bottom-layer of the other cavity room (200) is smaller than the sum of area of all air-channels which connects the other set of air-channels (255) from the bottom-layer of the other cavity room (200) with the vacuum source, such as a vacuum-pump.

In a preferred embodiment the other bottom layer (250) comprises a thermoplastic polymer resin or metal, more preferably is an engineering plastic composition, aluminium or comprises polyethylene terephthalate (PET), polyamide (PA), high-density polyethylene (HDPE), polytetrafluoroethylene (PTFE), polyoxymethylene (POM) and/or polyaryletherketone (PAEK).

The vacuum table may comprise a plurality of layers on top of each other which are connected to each other by glue or other means wherein for example:
a layer forms the set of walls (220); and/or
a layer forms a ceiling in a cavity room; and/or
a layer forms the bottom layer (250) in a cavity room; and/or
a layer forms the another set of walls (220); and/or
a layer forms a ceiling in the another cavity room; and/or
a layer forms the bottom layer (250) in the another cavity room (200).

Such a layer comprises a thermoplastic polymer resin or metal, more preferably is an engineering plastic composition, aluminium or comprises polyethylene terephthalate (PET), polyamide (PA), high-density polyethylene (HDPE), polytetrafluoroethylene (PTFE), polyoxymethylene (POM) and/or polyaryletherketone (PAEK).

### Inkjet Printing Device

An inkjet printing device, such as an inkjet printer, is a marking device that is using a printhead or a printhead assembly with one or more printheads, which jets a liquid, as droplets or vaporized liquid, on a inkjet receiver, also called print-media. A pattern that is marked by jetting of the inkjet printing device on a inkjet receiver is preferably an image. The pattern may be achromatic or chromatic colour.

The inkjet printer is preferably a wide-format inkjet printer. Wide-format inkjet printers are generally accepted to be any inkjet printer with a print width over 17 inches. Inkjet printers with a print width over the 100 inches are generally called super-wide printers or grand format printers. Wide-format printers are mostly used to print banners, posters, textiles and general signage and in some cases may be more economical than short-run methods such as screen printing. Wide format printers generally use a roll of inkjet receiver rather than individual sheets of inkjet receiver but today also wide format printers exist with a printing table whereon inkjet receiver is loaded. A wide-format printer preferably comprises a belt step conveyor system.

A printing table in the inkjet printer may move under a printhead or a gantry may move a printhead over the printing table. These so called flat-table digital printers most often are used for the printing of planar inkjet receivers, ridged inkjet receivers and sheets of flexible inkjet receivers. They may incorporate IR-dryers or UV-dryers to prevent prints from sticking to each other as they are produced. An example of a wide-format printer and more specific a flat-table digital printer is disclosed in EP1881903 (AGFA GRAPHICS NV).

The inkjet printer may perform a single pass printing method. In a single pass printing method the inkjet printheads usually remain stationary and the inkjet receiver is transported once under the one or more inkjet printheads. In a single pass printing method the method may be performed by using page wide inkjet printheads or multiple staggered inkjet printheads which cover the entire width of the inkjet receiver. An example of a single pass printing method is disclosed in EP2633998 (AGFA GRAPHICS NV). Such inkjet printer is also a called a single pass inkjet printer.

The inkjet printer may mark first a transfer belt that in a second step transfer the marking to an inkjet receiver. The inkjet printer preferably perform a printing method which comprises directing droplets of an inkjet ink onto an intermediate transfer member, such as transfer belt, to form an ink image, the ink including an organic polymeric resin and a colouring agent in an aqueous carrier, and the transfer member having a hydrophobic outer surface so that each ink droplet in the ink image spreads on impinging upon the intermediate transfer member to form an ink film. The inkjet ink is dried while the inkjet ink image is being transported by the intermediate transfer member by evaporating the aqueous carrier from the ink image to leave a residue film of resin and colouring agent. The residue film is then transferred to the inkjet receiver. The chemical compositions of the inkjet ink and of the surface of the intermediate transfer member are selected such that attractive intermolecular forces between molecules in the outer skin of each droplet and on the surface of the intermediate transfer member counteract the tendency of the ink film produced by each droplet to bead under the action of the surface tension of the aqueous carrier, without causing each droplet to spread by wetting the surface of the intermediate transfer member.

The inkjet printer may mark a broad range of inkjet receivers, also called print-media, such as folding carton, acrylic plates, honeycomb board, corrugated board, foam, medium density fibreboard, solid board, rigid paper board, fluted core board, plastics, aluminium composite material, foam board, corrugated plastic, carpet, textile, thin aluminium, paper, rubber, adhesives, vinyl, veneer, varnish blankets, wood, flexographic plates, metal based plates, fibreglass, plastic foils, transparency foils, adhesive PVC sheets, impregnated paper and others. An inkjet receiver may comprise an inkjet acceptance layer. An inkjet receiver may be a paper substrate or an impregnated paper substrate or a thermosetting resin impregnated paper substrate.

Preferably the inkjet printer comprises one or more printheads jetting UV curable ink to mark inkjet receiver and a UV source (=Ultra Violet source), as dryer system, to cure the inks after marking. Spreading of a UV curable inkjet ink on an inkjet receiver may be controlled by a partial curing or “pin curing” treatment wherein the ink droplet is “pinned”, i.e. immobilized where after no further spreading occurs. For example, WO 2004/002746 (INCA) discloses an inkjet printing method of printing an area of a inkjet receiver in a plurality of passes using curable ink, the method comprising depositing a first pass of ink on the area; partially curing ink deposited in the first pass; depositing a second pass of ink on the area; and fully curing the ink on the area.

A preferred configuration of UV source is a mercury vapour lamp. Within a quartz glass tube containing e.g. charged mercury, energy is added, and the mercury is vaporized and ionized. As a result of the vaporization and ionization, the high-energy free-for-all of mercury atoms, ions, and free electrons results in excited states of many of the mercury atoms and ions. As they settle back down to their ground state, radiation is emitted. By controlling the pressure that exists in the lamp, the wavelength of the radiation that is emitted can be somewhat accurately controlled, the goal being of course to ensure that much of the radiation that is emitted falls in the ultraviolet portion of the spectrum, and at wavelengths that will be effective for UV curable ink curing. Another preferred UV source is an UV-Light Emitting Diode, also called an UV-LED.

The inkjet printer may comprise an IR source (=Infra Red source) to solidify the ink by infra-red radiation. The IR source is preferably a NIR source (=Near Infra Red source) such as a NIR lamp. The IR source may comprise carbon infrared emitters which has a very short response time.

The IR source or UV source in the above preferred embodiments create a curing zone on the air-permeable media-support-layer (100) to immobilize jetted ink on the inkjet receiver.

The inkjet printer may comprise corona discharge equipment to treating the inkjet receiver before the inkjet receiver passes a printhead of the inkjet printer because some inkjet receivers have chemically inert and/or nonporous top-surfaces leading to a low surface energy which may result in bad print quality.

The inkjet printer is preferably an industrial inkjet printer such as a textile inkjet printer, corrugated fibreboard inkjet printer, decoration inkjet printer, 3D inkjet printer.

### Computer-to-Plate System

The inkjet printer of the embodiment may be used to create printing plates used for computer-to-plate (CTP) systems in which a proprietary liquid is jetted onto a metal base to create an imaged plate from the digital record. These plates require no processing or post-baking and can be used immediately after the ink-jet imaging is complete. Another advantage is that platesetters with an inkjet printer is less expensive than laser or thermal equipment normally used in computer-to-plate (CTP) systems. Preferably, the object that may be jetted by the embodiment of the inkjet printer is a lithographic printing plate. An example of such a lithographic printing plate manufactured by an inkjet printer is disclosed EP1179422 B (AGFA GRAPHICS NV).

The handling of printing plates on an air-permeable media-support-layer (100) is difficult due to uncontrolled adhering of this inkjet receiver against the air-permeable media-support-layer (100). Heat on the inkjet receiver may cause a curvature effect on the inkjet receiver, which can not be hold down on current air-permeable media-support-layer (100)s so the inkjet receiver may crash against a printhead from the inkjet printer. If no extra guiding means are implemented in the inkjet printer to hold down the printing plate which introduces an extra manufacturing cost. For example in a hot printing area and/or hot curing area, if available, the adhering of such printing plates against the air-permeable media-support-layer (100) is less. But in the present invention the connection, the hold-down and flat-down, of the inkjet receiver with the air-permeable media-support-layer (100) is guaranteed even in these hot printing area and/or curing area, if available, from the inkjet printer.

### Textile Inkjet Printer

Preferably, the inkjet printer is a textile inkjet printer, performing a textile inkjet printing method. The handling of such inkjet receivers on an air-permeable media-support-layer (100) is difficult due to uncontrolled adhering of the inkjet receiver against the air-permeable media-support-layer (100) due to easy crinkle of the inkjet receiver while transporting and/or heat upon the surface of the textile, for example in a hot print zone and/or hot curing zone This crinkle effect on the inkjet receiver can not be hold down and hold flat on current air-permeable media-support-layer (100)s so the inkjet receiver may touch against a printhead from the inkjet printer. In addition, crinkled textile is not acceptable for sale for example by bad print quality if the textile was not flat while printed. If no extra guiding means are implemented in the inkjet printer to hold down and flat the textile which introduces an extra manufacturing cost. For example in a hot printing area and/or hot curing area, if available, the crinkle effect of the textile can be become bigger. However, in the present invention the connection, the hold-down and flat-down, of the inkjet receiver with the air-permeable media-support-layer (100) is guaranteed even in these hot printing area and/or curing area, if available, from the inkjet printer. The present invention has also the advantage that no imprinting exists of the dimple pattern in the textile after printing. The textile is preferably pre-treated by corona treatment by corona discharge equipment because some textiles have chemically inert and nonporous surfaces leading to a low surface energy. In addition, some textiles also have issues with shrinkage, which is avoided by the present invention by a good overall coupling of the textile on the air-permeable media-support-layer (100). This is a very high advantage for a textile inkjet printer. Currently sticky conveyor belts are used to avoid this shrinkage issue on textiles but therefore the conveyor belts have to be applied regularly with glue but this is not needed with the present invention.

A textile in a textile inkjet printer is a woven or non-woven textile. A textile is preferably selected from the group consisting of cotton textiles, silk textiles, flax textiles, jute textiles, hemp textiles, modal textiles, bamboo fibre textiles, pineapple fibre textiles, basalt fibre textiles, ramie textiles, polyester based textiles, acrylic based textiles, glass fibre textiles, aramid fibre textiles, polyurethane textiles, high density polyethylene textiles and mixtures thereof.

The textile may be transparent, translucent or opaque.

A major advantage of the present invention is that printing can be performed on a wide range of textiles. Suitable textiles can be made from many materials. These materials come from four main sources: animal (e.g. wool, silk), plant (e.g. cotton, flax, jute), mineral (e.g. asbestos, glass fibre), and synthetic (e.g. nylon, polyester, acrylic). Depending on the type of material, it can be knitted, woven or non-woven textile.

The textile is preferably selected from the group consisting of cotton textiles, silk textiles, flax textiles, jute textiles, hemp textiles, modal textiles, bamboo fibre textiles, pineapple fibre textiles, basalt fibre textiles, ramie textiles, polyester based textiles, acrylic based textiles, glass fibre textiles, aramid fibre textiles, polyurethane textiles (e.g. Spandex or Lycra™), high density polyethylene textiles (Tyvek™) and mixtures thereof.

Suitable polyester textile includes polyethylene terephthalate textile, cation dyeable polyester textile, acetate textile, diacetate textile, triacetate textile, polylactic acid textile and the like.

Applications of these textiles include automotive textiles, canvas, banners, flags, interior decoration, clothing, swimwear, sportswear, ties, scarves, hats, floor mats, doormats, carpets, mattresses, mattress covers, linings, sacking, upholstery, carpets, curtains, draperies, sheets, pillowcases, flame-retardant and protective fabrics, and the like. In a preferred embodiment the present invention is comprised in the manufacturing of one of these applications. Polyester fibre is used in all types of clothing, either alone or blended with fibres such as cotton. Aramid fibre (e.g. Twaron) is used for flame-retardant clothing, cut-protection, and armour. Acrylic is a fibre used to imitate wools.

It is found that in the present invention the jetted ink or liquid penetrates easier in the fibres of a textile, probably by the distribution of the air-flow inside the cavities, comprised in the vacuum table.

### Leather Inkjet Printer

Preferably the inkjet printer is a leather inkjet printer, performing a leather inkjet printing method. The handling of such inkjet receivers on an air-permeable media-support-layer (100) is difficult due to uncontrolled adhering of the inkjet receiver against the air-permeable media-support-layer (100) due to easy crinkle of the inkjet receiver while transporting and/or heat upon the surface of the leather, for example in a hot print zone and/or hot curing zone This crinkle effect, especially at the edges, on the inkjet receiver can not be hold down and hold flat on current air-permeable media-support-layer (100)s so the inkjet receiver may touch against a printhead from the inkjet printer. Also crinkled leather is not acceptable for sale for example by bad print quality if the leather was not flat while printed. If no extra guiding means are implemented in the inkjet printer to hold down and flat the leather which introduces an extra manufacturing cost. For example in a hot printing area and/or hot curing area, if available, the crinkle effect of the leather can be become bigger. However, in the present invention the connection, the hold-down and flat-down, of the inkjet receiver with the air-permeable media-support-layer (100) is guaranteed even in these hot printing area and/or curing area, if available, from the inkjet printer. The present invention has also the advantage that no imprinting exists of the dimple pattern in the leather after printing. The leather is preferably pre-treated by corona treatment by corona discharge equipment because some leathers, such as artificial leathers; have chemically inert and nonporous surfaces leading to a low surface energy. In addition, some leathers also have issues with shrinkage, which is avoided by the present invention by a good overall coupling of the leather on the air-permeable media-support-layer (100). This is a very high advantage for a leather inkjet printer. Artificial leather is a fabric intended to substitute leather in fields such as upholstery, clothing, and fabrics, and other uses where a leather-like finish is required but the actual material is cost-prohibitive, unsuitable, or unusable for ethical reasons.

Artificial leather is marketed under many names, including “leatherette”, “faux leather”, and “pleather”. Suitable artificial leather includes poromeric imitation leather, corfam, koskin and leatherette. Suitable commercial brands include Biothane™ from BioThane Coated Webbing, Birkibuc™ and Birko-Flor™ from Birkenstock, Kydex™ from Kleerdex, Lorica™ from Lorica Sud, and Fabrikoid™ from DuPontm.

### Corrugated Fibreboard Inkjet Printer

Preferably, the inkjet printer is a corrugated fibreboard inkjet printer, performing a corrugated fibreboard inkjet printing method. The inkjet receiver of such inkjet printer is always corrugated fibreboard. Corrugated fibreboard is a paper-based material consisting of a fluted corrugated medium and one or two flat linerboards. The corrugated medium and linerboard board are preferably made of kraft containerboard and/or preferably, corrugated fibreboard is between 3 mm and 15 mm thick. Corrugated fibreboard is sometimes called corrugated cardboard; although cardboard might be any heavy paper-pulp based board.

The handling of such inkjet receivers on an air-permeable media-support-layer (100) is difficult due to uncontrolled adhering of the inkjet receiver against the air-permeable media-support-layer (100). Differences of humidity in bottom and top layer of the inkjet receiver may cause a curvature effect on the inkjet receiver, which cannot be hold down on current air-permeable media-support-layers so the inkjet receiver may crash against a printhead from the inkjet printer. If no extra guiding means are implemented in the inkjet printer to hold down the corrugated fibreboard which introduces an extra manufacturing cost. For example in a hot printing area and/or hot curing area, if available, the differences of humidity in bottom and top layer of the corrugated fibreboard can be become bigger. However, in the present invention the connection, the hold-down, of this inkjet receiver with the air-permeable media-support-layer (100) is guaranteed even in these hot printing area and/or curing area, if available, from the inkjet printer.

### Plastic Foil Inkjet Printer

Preferably the inkjet printer is a plastic foil inkjet printer, performing a plastic foil inkjet printing method. The inkjet receiver of such inkjet printer is always plastic foil, such as polyvinyl chloride (PVC), polyethylene (PE), low density polyethylene (LDPE), polyvinylidene chloride (PVdC). The thickness of a plastic foil is preferably between 30 and 200 μm, more preferably between 50 and 100 μm and most preferably between 60 to 80 μm. In a preferred embodiment the plastic foil is suitable for making plastic bags.

The handling of such inkjet receivers on an air-permeable media-support-layer (100) is difficult due to uncontrolled adhering of the inkjet receiver against the air-permeable media-support-layer (100) due to easy crinkle of the inkjet receiver while transporting and/or heat upon the surface of the plastic foil, for example in a hot print zone and/or hot curing zone This crinkle effect on the inkjet receiver can not be hold down and hold flat on current air-permeable media-support-layer (100)s so the inkjet receiver may touch against a printhead from the inkjet printer. Also crinkled plastic foil is not acceptable for sale for example by bad print quality if the plastic foil was not flat while printed. If no extra guiding means are implemented in the inkjet printer to hold down and flat the plastic foil which introduces an extra manufacturing cost. For example in a hot printing area and/or hot curing area, if available, the crinkle effect of the plastic foil can be become bigger. However, in the present invention the connection, the hold-down and flat-down, of the inkjet receiver with the air-permeable media-support-layer (100) is guaranteed even in these hot printing area and/or curing area, if available, from the inkjet printer. The present invention has also the advantage that no imprinting exists of the dimple pattern in the plastic foil after printing. The plastic foil is preferably pre-treated by corona treatment by corona discharge equipment because most plastics, such as polyethylene and polypropylene, have chemically inert and nonporous surfaces leading to a low surface energy.

### Corona Discharge Equipment

Corona discharge equipment consists of a high-frequency power generator, a high-voltage transformer, a stationary electrode, and a treater ground roll. Standard utility electrical power is converted into higher frequency power which is then supplied to the treater station. The treater station applies this power through ceramic or metal electrodes over an air gap onto the material's surface.

A corona treatment can be applied in the present invention to unprimed inkjet receivers, but also to primed inkjet receivers.

### Vacuum Table

A vacuum table is a table wherein the inkjet receiver is connected to the printing table by vacuum pressure when the inkjet receiver supported on an air-permeable media-support-layer (100). A vacuum table is also called a porous printing table. Between the inkjet receiver and the vacuum table may be a vacuum belt when a vacuum belt is wrapped around the vacuum table.

Preferably, the vacuum table provides a pressure differential by a vacuum chamber at the air-permeable media-support-layer (100) to create a vacuum zone and at the bottom-surface of the printing table.

The width and/or height of the vacuum table is preferably from 1.0 m until 10 m. The larger the width and/or height, the larger the inkjet receiver may be supported by the vacuum table which is an economical benefit.

The apertures at the air-permeable media-support-layer (100) may be circular, elliptical, square, rectangular shaped, parallel with this support.

Preferably, the vacuum table of the embodiment comprising a honeycomb structure plate underneath the bottom layers of the plurality of cavity rooms. The honeycomb cores, as part of the air-channels, in the honeycomb structure plate results in a better uniform vacuum distribution on the support surface of the vacuum table by the air-flow from the vacuum source. A honeycomb core is preferably sinusoidal or hexagonal shaped.

If a honeycomb structure plate is comprised in the vacuum table the dimensions and the amount of honeycomb cores should be sized and frequently positioned to provide sufficient vacuum pressure to the vacuum table. The dimensions between two neighbour honeycomb cores may be different.

The air-permeable media-support-layer (100) of the printing table should be constructed to prevent damaging of an inkjet receiver or vacuum belt if applicable. For example, the apertures at this support-layer may have rounded edges. This support-layer of the printing table may be configured to have low frictional specifications.

The vacuum table is preferably parallel to the ground whereon the inkjet printing system is connected to avoid misaligned printed patterns.

The vacuum pressure in a vacuum zone on the air-permeable media-support-layer (100) may couple the inkjet receiver and the vacuum table by sandwiching a vacuum belt that carries/supporting the inkjet receiver. The coupling is preferably done while printing to hold down the inkjet receiver to avoid bad alignment and colour-on-colour register problems. The vacuum pressure in a vacuum zone on the air-permeable media-support-layer (100) may apply sufficient normal force to the vacuum belt when the vacuum belt is moving and carrying an inkjet receiver in the conveying direction. The vacuum pressure may also prevent any fluttering and/or vibrating of the vacuum belt or inkjet receiver on the vacuum belt. The vacuum pressure in a vacuum zone may be adapted while printing.

The air-permeable media-support-layer (100) or a portion of it may be coated to have easy cleaning performances e.g. as result of dust or ink leaks. The coating is preferably a dust repellent and/or ink repellent and/or hydrophobic coating. Preferably, the air-permeable media-support-layer (100) or a portion of it is treated with an ink repelling hydrophobic method by creating a lubricious and repelling surface, which reduces friction.

### Vacuum Chamber

A vacuum chamber is a rigid enclosure, which is constructed by many materials; preferably, it may comprise a metal. The choice of the material is based on the strength, pressure and the permeability. The material of the vacuum chamber may comprise stainless steel, aluminium, mild steel, brass, high density ceramic, glass or acrylic.

A vacuum source, such as a vacuum pump, provides a vacuum pressure inside a vacuum chamber and is connected by a vacuum source connector, such as a tube, to a vacuum source input such as aperture in the vacuum chamber. Between the vacuum source connector a vacuum controller, such as a valve or a tap, may be provided to control the vacuum in a sub-vacuum chamber wherein the aperture is positioned.

To prevent contamination, such as paper dust, inkjet receiver fibres, ink, ink residues and/or ink debris such as cured ink, to contaminate via the set of air-channels of the printing table and/or the set of vacuum-belt-air-channels from the conveyor belt the interior means of the vacuum pump, a filter, such as an air filter and/or coalescence filter, may be connected to the vacuum pump connector. Preferably, a coalescence filter, as filter, is connected to the vacuum pump connector to split liquid and air from the contamination in the vacuum pump connector.

The vacuum source is preferably a radial vacuum pump, which achieves high delivery air volumes with very little pulsation, so a uniform suction force with low pulsation and/or constant vacuum is guaranteed at the vacuum zones on the air-permeable media-support-layer (100). By integrating a frequency inverter in this vacuum pump, the volumetric flow can be matched to the requirements of vacuum set point.

### Vacuum Belt

Preferably the vacuum belt, also called a porous conveyor belt, which is an example of an air-permeable media-support-layer (100), has two or more layers of materials wherein an under layer provides linear strength and shape, also called the carcass and an upper layer called the cover or the support side. The carcass is preferably a woven fabric web and more preferably a woven fabric web of polyester, nylon, glass fabric or cotton. The material of the cover is preferably various rubber and more preferably plastic compounds and most preferably thermoplastic polymer resins. Also other exotic materials for the cover can be used such as silicone or gum rubber when traction is essential. An example of a multi-layered conveyor belt for a general belt conveyor system wherein the cover having a gel coating is disclosed in US 20090098385 A1 (FORBO SIEBLING GMBH).

Preferably, the vacuum belt comprises glass fabric or the carcass is glass fabric and more preferably the glass fabric, as carcass, has a coated layer on top comprising a thermoplastic polymer resin and most preferably the glass fabric has a coated layer on top comprising polyethylene terephthalate (PET), polyamide (PA), high-density polyethylene (HDPE), polytetrafluoroethylene (PTFE), polyoxymethylene (POM), polyurethaan (PU) and/or Polyaryletherketone (PAEK). The coated layer may also comprise aliphatic polyamides, polyamide 11 (PA 11), polyamide 12 (PA 12), UHM-HDPE, HM-HDPE, Polypropylene (PP), Polyvinyl chloride (PVC), Polysulfone (PS), Poly(p-phenylene oxide) (PPOTM), Polybutylene terephthalate (PBT), Polycarbonate (PC), Polyphenylene sulphide (PPS).

Preferably the vacuum belt is and endless vacuum belt. Examples and figures for manufacturing an endless multi-layered vacuum belt for a general belt conveyor system are disclosed in EP 1669635 B (FORBO SIEBLING GMBH).

The vacuum belt may also have a sticky cover, which holds the inkjet receiver on the vacuum belt while it is carried from start location to end location. Said vacuum belt is also called a sticky vacuum belt. The advantageous effect of using a sticky vacuum belt allows an exact positioning of an inkjet receiver on the sticky vacuum belt. Another advantageous effect is that the inkjet receiver shall not be stretched and/or deformed while the inkjet receiver is carried from start location to end location. The adhesive on the cover is preferably activated by an infrared drier to make the vacuum belt sticky. The adhesive on the cover is more preferably a removable pressure sensitive adhesive. The combination of sticky belt with a vacuum belt comprising a set of dimples each forming air-cups gives a boost at the technology in vacuum belts for inkjet printers, especially for textile inkjet printers.

Another preferable way of a sticky vacuum belt is a vacuum belt which comprises synthetic setae to hold an inkjet receiver stable, e.g. not formable, while printing on an inkjet receiver. Holding the inkjet receiver stable while printing on the inkjet receiver is necessary e.g. to avoid misalignment or color shifts in the printed pattern on the inkjet receiver. The synthetic setae are emulations of setae found on the toes of geckos.

The top-surface of the vacuum belt or a portion of the vacuum belt, such as its air-channels, may be coated to have easy cleaning as result of e.g. dust or ink leaks. The coating is preferably a dust repellent and/or ink repellent and/or hydrophobic coating. Preferably, the top-surface of the vacuum belt or a portion of the vacuum, belt is treated with an ink repelling hydrophobic method by creating a lubricious and repelling surface, which reduces friction.

A layer of neutral fibres in the vacuum belt is preferably constructed at a distance from the bottom surface between 2 mm and 0.1 mm, more preferably between 1 mm and 0.3 mm. This layer with neutral fibres is of big importance to have a straight conveying direction with minimal side force on the vacuum belt and/or minimized fluctuation of the Pitch Line of the vacuum belt for high printing precision transportation.

The top surface of the vacuum belt comprises preferable hard urethane with a preferred thickness (measured from top surface to bottom surface) between 0.2 to 2.5 mm. The total thickness (measured from top surface to bottom surface) of the vacuum belt is preferably between 1.2 to 7 mm. The top-surface is preferably high resistance to solvents so the inkjet printer is useful in an industrial printing and/or manufacturing environment.

### Printhead

A printhead is a means for jetting a liquid on an inkjet receiver through a nozzle. The nozzle may be comprised in a nozzle plate that is attached to the printhead. A printhead preferably has a plurality of nozzles, which may be comprised in a nozzle plate. A set of liquid channels, comprised in the printhead, corresponds to a nozzle of the printhead, which means that the liquid in the set of liquid channels can leave the corresponding nozzle in the jetting method. The liquid is preferably an ink, more preferably an UV curable inkjet ink or water based inkjet ink, such as a water based resin inkjet ink. The liquid used to jet by a printhead is also called a jettable liquid. A high viscosity jetting method with UV curable inkjet ink is called a high viscosity UV curable jetting method. A high viscosity jetting method with water based inkjet ink is called a high viscosity water base jetting method.

The way to incorporate printheads into an inkjet printer is well known to the skilled person.

A printhead may be any type of printhead such as a valvejet printhead, piezoelectric printhead, thermal printhead, a continuous printhead type, electrostatic drop on demand printhead type or acoustic drop on demand printhead type or a page-wide printhead array, also called a page-wide inkjet array.

A printhead comprises a set of master inlets to provide the printhead with a liquid from a set of external liquid feeding units. Preferably, the printhead comprises a set of master outlets to perform a recirculation of the liquid through the printhead. The recirculation may be done before the droplet forming means but it is more preferred that the recirculation be done in the printhead itself, so called through-flow printheads. The continuous flow of the liquid in a through-flow printheads removes air bubbles and agglomerated particles from the liquid channels of the printhead, thereby avoiding blocked nozzles that prevent jetting of the liquid. The continuous flow prevents sedimentation and ensures a consistent jetting temperature and jetting viscosity. It also facilitates auto-recovery of blocked nozzles, which minimizes liquid, and receiver wastage.

The printhead of the present invention is preferably suitable for jetting a liquid having a jetting viscosity of eight mPa·s to 3000 mPa·s. A preferred printhead is suitable for jetting a liquid having a jetting viscosity of twenty mPa·s to 200 mPa·s; and more preferably suitable for jetting a liquid having a jetting viscosity of fifty mPa·s to 150 mPa·s.

### Valvejet Printhead

A preferred printhead for the present invention is a so-called Valvejet printhead. Preferred valvejet printheads have a nozzle diameter between 45 and 600 μm. The valvejet printheads comprising a plurality of micro valves allow for a resolution of 15 to 150 dpi that is preferred for having high productivity while not comprising image quality. A Valvejet printhead is also called coil package of micro valves or a dispensing module of micro valves. The way to incorporate valvejet printheads into an inkjet printer is well known to the skilled person. For example, US 2012105522 (MATTHEWS RESOURCES INC) discloses a valvejet printer including a solenoid coil and a plunger rod having a magnetically susceptible shank. Suitable commercial valvejet printheads are chromoJET™ 200, 400 and 800 from Zimmer, Printos™ P16 from VideoJet and the coil packages of micro valve SMLD 300's from Fritz Gyger™. A nozzle plate of a valvejet printhead is often called a faceplate and is preferably made from stainless steel.

The droplet forming means of a valvejet printhead controls each micro valve in the valvejet printhead by actuating electromagnetically to close or to open the micro valve so that the medium flows through the liquid channel. Valvejet printheads preferably have a maximum dispensing frequency up to 3000 Hz.

### Belt Step Conveyor System

The embodiment of the inkjet printer comprises a vacuum belt, wrapped around the vacuum table, wherein the vacuum belt carries an inkjet receiver by moving from a start location to an end location in preferably successive distance movements also called discrete step increments. This is also called a belt step conveyor system.

The belt step conveyor system may be driven by an electric stepper motor to produce a torque to a pulley so by friction of the vacuum belt on the powered pulley the vacuum belt and the inkjet receiver is moved in a conveying direction. The use of an electric stepper motor makes the transport of a load more controllable e.g. to change the speed of conveying and move the load on the vacuum belt in successive distance movements. An example of a belt step conveying belt system with an electric stepper motor is described for the media transport of a wide-format printer in EP 1235690 A (ENCAD INC).

To know the distance of the successive distance movements in a belt step conveyor system, that is driven by an electric stepper motor to produce a torque to a pulley so by friction of the vacuum belt on the powered pulley the vacuum belt and the inkjet receiver is moved in a conveying direction substrate on the vacuum belt, so it can be communicated to other controllers such as a renderer of the inkjet printer or the controllers of a inkjet head, an encoder is comprised on one of the pulleys that are linked with the vacuum belt.

But preferably the encoder measures the linear feed of the vacuum belt directly on the vacuum belt by a measuring device comprising a position sensor that may attachable to the vacuum belt and a stationary reference means wherein the relative position of the position sensor to the stationary reference means is detected. The position sensor comprises preferably an optical sensor, which may interpret the distance between the position sensor and the stationary reference means on a distance ruler, such as an encoder strip, which is preferably comprised at the stationary reference means. Preferably, the measuring device comprises a gripper to grip the position sensor to the conveying belt. The measuring device may comprising a guide means through which the position sensor relative to the stationary reference means is guided —preferably linear. By attaching the position sensor to the vacuum belt while moving the vacuum belt in a conveying direction, the distance can be measured between the position sensor and the stationary reference means. Between the discrete steps increments the position sensor may release the vacuum belt and may return to the stationary reference.

### Piezoelectric Printheads

Another preferred printhead for the present invention is a piezoelectric printhead. Piezoelectric printhead, also called piezoelectric inkjet printhead, is based on the movement of a piezoelectric ceramic transducer, comprised in the printhead, when a voltage is applied thereto. The application of a voltage changes the shape of the piezoelectric ceramic transducer to create a void in a liquid channel, which is then filled with liquid. When the voltage is again removed, the ceramic expands to its original shape, ejecting a droplet of liquid from the liquid channel.

The droplet forming means of a piezoelectric printhead controls a set of piezoelectric ceramic transducers to apply a voltage to change the shape of a piezoelectric ceramic transducer. The droplet forming means may be a squeeze mode actuator, a bend mode actuator, a push mode actuator, a shear mode actuator or another type of piezoelectric actuator.

Suitable commercial piezoelectric printheads are TOSHIBA TEC™ CK1 and CK1L from TOSHIBA TEC™ and XAAR™ 2001 from XAAR™.

A liquid channel in a piezoelectric printhead is also called a pressure chamber.

Between a liquid channel and a master inlet of the piezoelectric printheads, there is a manifold connected to store the liquid to supply to the set of liquid channels.

The piezoelectric printhead is preferably a through-flow piezoelectric printhead. In a preferred embodiment, the recirculation of the liquid in a through-flow piezoelectric printhead flows between a set of liquid channels and the inlet of the nozzle wherein the set of liquid channels corresponds to the nozzle.

In a preferred embodiment in a piezoelectric printhead, the minimum drop size of one single jetted droplet is from 0.1 pL to 300 pL, in a more preferred embodiment the minimum drop size is from 1 pL to 30 pL, in a most preferred embodiment the minimum drop size is from 1.5 pL to 15 pL. By using grayscale inkjet head technology, multiple single droplets may form larger drop sizes.

In a preferred embodiment, the piezoelectric printhead has a drop velocity from 3 meters per second to 15 meters per second, in a more preferred embodiment the drop velocity is from 5 meters per second to 10 meters per second, in a most preferred embodiment the drop velocity is from 6 meters per second to 8 meters per second.

In a preferred embodiment, the piezoelectric printhead has a native print resolution from 25 DPI to 2400 DPI, in a more preferred embodiment the piezoelectric printhead has a native print resolution from 50 DPI to 2400 DPI and in a most preferred embodiment the Piezoelectric printhead has a native print resolution from 150 DPI to 3600 DPI.

In a preferred embodiment with the piezoelectric printhead, the jetting viscosity is from eight mPa·s to 200 mPa·s more preferably from 25 mPa·s to 100 mPa·s and most preferably from thirty mPa·s to 70 mPa·s.

In a preferred embodiment with the piezoelectric printhead the jetting temperature is from 10° C. to 100° C. more preferably from 20° C. to 60° C. and most preferably from 30° C. to 50° C.

The nozzle spacing distance of the nozzle row in a piezoelectric printhead is preferably from ten μm to 200 μm; more preferably from ten μm to 85 μm; and most preferably from ten μm to 45 μm.

### Inkjet Ink

In a preferred embodiment, the liquid in the printhead is an aqueous curable inkjet ink, and in a most preferred embodiment, the inkjet ink is an UV curable inkjet ink.

A preferred aqueous curable inkjet ink includes an aqueous medium and polymer nanoparticles charged with a polymerizable compound. The polymerizable compound is preferably selected from the group consisting of a monomer, an oligomer, a polymerizable photoinitiator, and a polymerizable co-initiator.

An inkjet ink may be a colourless inkjet ink and be used, for example, as a primer to improve adhesion or as a varnish to obtain the desired gloss. However, preferably the inkjet ink includes at least one colorant, more preferably a colour pigment. The inkjet ink may be a cyan, magenta, yellow, black, red, green, blue, orange or a spot colour inkjet ink, preferable a corporate spot colour inkjet ink such as red colour inkjet ink of Coca-Cola™ and the blue colour inkjet inks of VISA™ or KLM™. In a preferred embodiment, the inkjet ink comprises metallic particles or comprising inorganic particles such as a white inkjet ink.

In a preferred embodiment, an inkjet ink contains one or more pigments selected from the group consisting of carbon black, C.I. Pigment Blue 15:3, C.I. Pigment Blue 15:4, C.I Pigment Yellow 150, C.I Pigment Yellow 151, C.I. Pigment Yellow 180, C.I. Pigment Yellow 74, C.I Pigment Red 254, C.I. Pigment Red 176, C.I. Pigment Red 122, and mixed crystals thereof.

### Jetting Viscosity and Jetting Temperature

The jetting viscosity is measured by measuring the viscosity of the liquid at the jetting temperature.

The jetting viscosity may be measured with various types of viscometers such as a Brookfield DV-II+ viscometer at jetting temperature and at 12 rotations per minute (RPM) using a CPE 40 spindle which corresponds to a shear rate of 90 s⁻¹ or with the HAAKE Rotovisco 1 Rheometer with sensor C60/1 Ti at a shear rate of 1000 s⁻¹.

In a preferred embodiment, the jetting viscosity is from 10 mPa·s to 200 mPa·s more preferably from 25 mPa·s to 100 mPa·s and most preferably from 30 mPa·s to 70 mPa·s.

The jetting temperature may be measured with various types of thermometers.

The jetting temperature of jetted liquid is measured at the exit of a nozzle in the printhead while jetting or it may be measured by measuring the temperature of the liquid in the liquid channels or nozzle while jetting through the nozzle.

In a preferred embodiment, the jetting temperature is from 10° C. to 100° C. more preferably from 20° C. to 60° C. and most preferably from 30° C. to 50° C.

### Principle of Working

The constant ‘a’ in formula I-a en I-b is determined in normal European weathering conditions as equal to 1.2 (row A in tables). The constant ‘a’ depends on several conditions such as air-temperature and air-humidity. A method to calculate this constant ‘a’ is disclosed on the website http://www.tlv.com/global/TI/calculator/air-flow-rate-through-orifice.html but also on articles, books about discharge coefficient; flow coefficient and the efficiency of (air)flow in orifices.

The vacuum source, in here a vacuum pump, has a vacuum set point of 40 mbar (row B in tables, ΔP as in formula I-a, I-b) and all orifices, holes in the following examples are circular and equally dimensioned in the air-permeable part of the present invention and equally dimensioned (but different than dimensioned as the holes in the air-permeable part) in the bottom-layer of a cavity room (200) underneath the air-permeable part.

dₑ=diameter of hole(s) in the air-permeable part (row F in tables) in mm.
dₒ=diameter of hole(s) in the bottom layer (250) (row C in tables) in mm.
d_{o,eq,n}=diameter of the equivalent hole in the bottom layer (250) in mm wherein n holes (row D in tables) with do are comprised which is calculated by formula III (row E in tables) Row G in the tables is the certain number (m) of open holes, also called unused holes, in the air-permeable part and wherein
Row H in the tables is the equivalent diameter of these m open holes, calculated by formula III (d_{e, eq,m}).
Row I in the tables is the calculation of the circular area with this equivalent diameter (=radius× radius× Pi) in mm².
Row J in the table is the air-flow over cascading orifices (e=hole(s) in the air-permeable part, o=hole(s) in the bottom layer) as calculated by formula II.
Row K in the table is the calculation of the pressure drop over the hole(s) in the bottom layer (250) (ΔPₒ) in mbar based on the calculated air-flow from Row K as calculated with the constant a from row A by formula I-b.
Row L in the table is the calculation of the pressure drop over the m open hole(s) in the air-permeable part (ΔPe) in mbar based on the calculated air-flow from Row K as calculated with the constant a from row A by formula I-b. The values in Row K and Row L depends on the vacuum set point of the vacuum source. If this power alters than also the values from these two rows shall grow.

The more holes are open (thus unused holes and not covered holes by print-media), the pressure drop over these open hole(s) grows while the pressure drop over the holes in the bottom layer (250) of the cavity room (200) decreases.

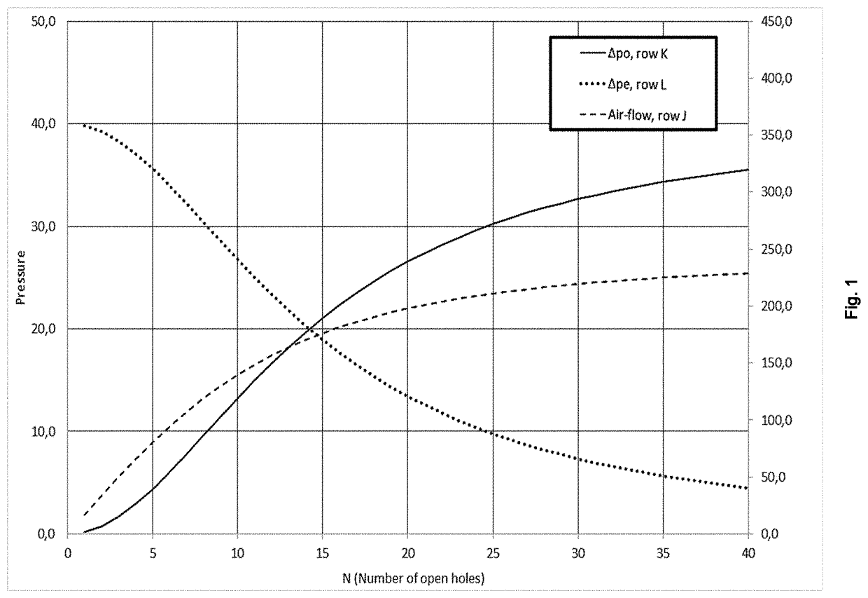

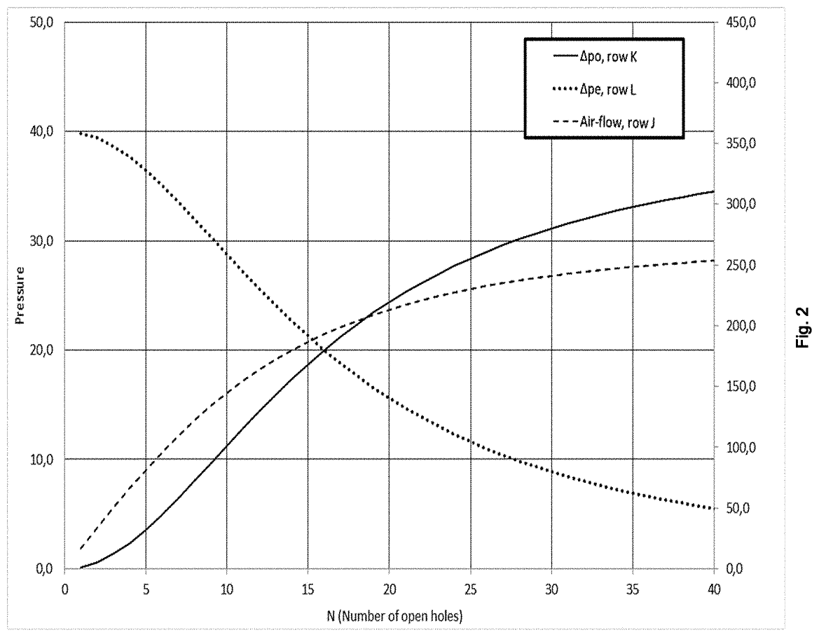

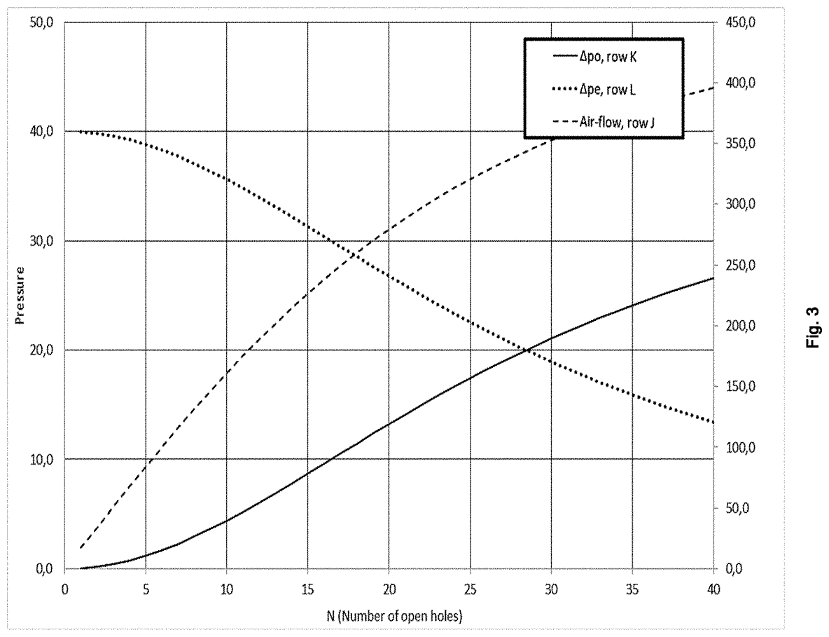

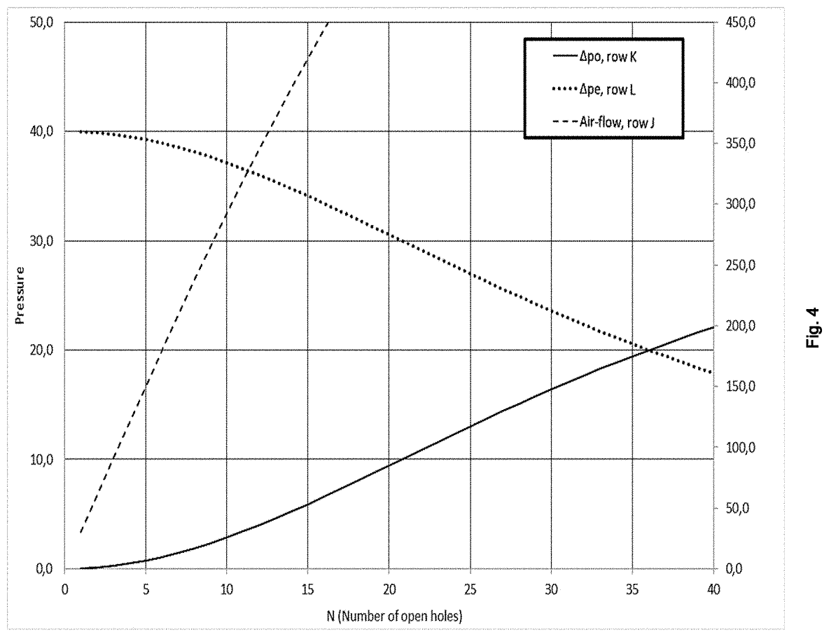

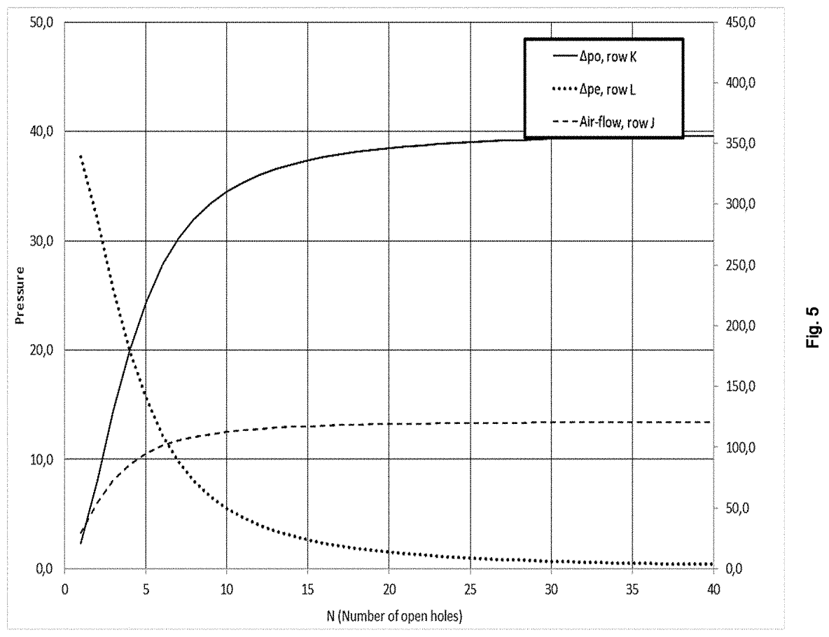

By the use of cavity rooms as prescribed for the present invention, shall for a certain number of open holes in the air-permeable part above a cavity room (200) the pressure drop over the open holes become plus minus the same as the pressure drop over the holes in the bottom layer (250) of this cavity room (200) (see FIG. 1, FIG. 2, FIG. 3, FIG. 4, FIG. 5), which is further defined as ‘the optimum’. Moreover, this is what the invention goes about: the cavity rooms solves that there is no loss of vacuum power or less loss of vacuum power at unused air-channels (=open holes, not covered by print-media) at the air-permeable part. The no loss of vacuum power or less loss of vacuum power makes it possible to use a less power vacuum source or to use a lower vacuum set point, which is for a large air-permeable media-support-layer (100) a serious economically benefit.

The plurality of cavities creates a plurality of vacuum zones on the air-permeable media-support-layer (100) so a plurality of print-media (300) can be supported on this support-layer.

If is found that if the ratio between
the equivalent diameter of each air-channel from the plurality of air-channels (105) comprised in the air-permeable part; and
the equivalent diameter of the set of air-channels (255) comprised in the bottom layer (250) of the cavity room is between 0.50 and 0.166, more preferably between 0.33 (=±1:3) and 0.2=(±1:5), most preferably between 0.275 (=+11:40) and 0.225=(±9:40), especially and/or preferably when the equivalent diameter of each air-channel comprised in the air-permeable part is between 0.5 mm and 4 mm. This gives ‘an optimum’ with not a high amount of air-channels in the air-permeable part, thus the area of the cavity room (200) can be manufactured small and thus a plurality of vacuum zones on the air-permeable media-support-layer (100) can be achieved. The amount of air-channels in the air-permeable part defines the needed vacuum set point of the vacuum source. If this amount is large than the vacuum set point of the vacuum source have to be chosen to be larger. Higher the vacuum set point, more expensive the vacuum source and energy consumption.

The difference ([row K−row L]/row B) between
the pressure drop over the hole(s) in the bottom layer (250) (ΔPₒ, row K); and
pressure drop over the holes in the air-permeable part (ΔPₑ, row L); and divided by the vacuum set point of the vacuum source (row B) is in a preferred embodiment between −0.5 and 0.5 else the loss of vacuum at the unused holes is too much.

The difference ([row K−row L]/row B) between
the pressure drop over the hole(s) in the bottom layer (250) (ΔPₒ, row K); and
pressure drop over the holes in the air-permeable part (ΔPe, row L); and divided by the vacuum set point of the vacuum source (row B) is in a more preferred embodiment between between −0.4 and 0.4 and most preferably between 0.0 and 0.5 or between 0.05 and 0.4.

Higher the total amount of holes in the air-permeable part, larger a vacuum set point is needed which can cause that a more expensive vacuum source is needed.

### Example 1

A graph from this example is illustrated in FIG. 1. In this example, there are two holes in the bottom layer (250) of the cavity room (200) with a diameter of 4 mm and a plurality of holes in the air-permeable part above this cavity room (200) (see TABLE 1) have a diameter of 1.5 mm. The ratio of the equivalent area of the hole(s) in the bottom layer (250) versus a hole in the air-permeable part is 3.77:1.

TABLE 1
(example 1)

| | | | | | | | | | | | |
|---|---|---|---|---|---|---|---|---|---|---|---|
| A | 1.2 | | | | | | | | | | |
| B | 40 | | | | | | | | | | |
| C | 4 | | | | | | | | | | |
| D | 2 | | | | | | | | | | |
| E | 5.7 | | | | | | | | | | |
| F | 1.5 | | | | | | | | | | |
| G | 1 | 2 | 3 | 5 | 7 | 9 | 11 | 13 | 15 | 17 | 19 |
| H | 1.5 | 2.1 | 2.6 | 3.4 | 4.0 | 4.5 | 5.0 | 5.4 | 5.8 | 6.2 | 6.5 |
| I | 1.8 | 3.5 | 5.3 | 8.8 | 12.4 | 15.9 | 19.4 | 23.0 | 26.5 | 30.0 | 33.6 |
| J | 17.0 | 33.8 | 50.1 | 80.5 | 107.2 | 129.9 | 148.6 | 163.9 | 176.2 | 186.3 | 194.4 |
| K | 0.2 | 0.8 | 1.7 | 4.4 | 7.8 | 11.4 | 15.0 | 18.2 | 21.1 | 23.5 | 25.6 |
| L | 39.8 | 39.2 | 38.3 | 35.6 | 32.2 | 28.6 | 25.0 | 21.8 | 18.9 | 16.5 | 14.4 |

### Example 2

A graph from this example is illustrated in FIG. 2. In this example, there is one hole in the bottom layer (250) of the cavity room (200) with a diameter of 6 mm and a plurality of holes in the air-permeable part above this cavity room (200) (see TABLE 2) have a diameter of 1.5 mm. The ratio of the equivalent area of the hole(s) in the bottom layer (250) versus a hole in the air-permeable part is 4.00:1.

TABLE 2
(example 2)

| | | | | | | | | | | | |
|---|---|---|---|---|---|---|---|---|---|---|---|
| A | 1.2 | | | | | | | | | | |
| B | 40 | | | | | | | | | | |
| C | 6 | | | | | | | | | | |
| D | 1 | | | | | | | | | | |
| E | 6.0 | | | | | | | | | | |
| F | 1.5 | | | | | | | | | | |
| G | 1 | 2 | 3 | 5 | 7 | 9 | 11 | 13 | 15 | 17 | 19 |
| H | 1.5 | 2.1 | 2.6 | 3.4 | 4.0 | 4.5 | 5.0 | 5.4 | 5.8 | 6.2 | 6.5 |
| I | 1.8 | 3.5 | 5.3 | 8.8 | 12.4 | 15.9 | 19.4 | 23.0 | 26.5 | 30.0 | 33.6 |
| J | 17.0 | 33.9 | 50.4 | 81.5 | 109.5 | 133.9 | 154.8 | 172.3 | 186.9 | 199.0 | 209.0 |
| K | 0.2 | 0.6 | 1.4 | 3.6 | 6.4 | 9.6 | 12.8 | 15.9 | 18.7 | 21.2 | 23.4 |
| L | 39.8 | 39.4 | 38.6 | 36.4 | 33.6 | 30.4 | 27.2 | 24.1 | 21.3 | 18.8 | 16.6 |

### Example 3

A graph from this example is illustrated in FIG. 3. In this example, there is one hole in the bottom layer (250) of the cavity room (200) with a diameter of 8 mm and a plurality of holes in the air-permeable part above this cavity room (200) (see TABLE 3) have a diameter of 1.5 mm. The ratio of the equivalent area of the hole(s) in the bottom layer (250) versus a hole in the air-permeable part is 5.33:1.

TABLE 3
(example 3)

| | | | | | | | | | | | |
|---|---|---|---|---|---|---|---|---|---|---|---|
| A | 1.2 | | | | | | | | | | |
| B | 40 | | | | | | | | | | |
| C | 8 | | | | | | | | | | |
| D | 1 | | | | | | | | | | |
| E | 8.0 | | | | | | | | | | |
| F | 1.5 | | | | | | | | | | |
| G | 1 | 2 | 3 | 5 | 7 | 9 | 11 | 13 | 15 | 17 | 19 |
| H | 1.5 | 2.1 | 2.6 | 3.4 | 4.0 | 4.5 | 5.0 | 5.4 | 5.8 | 6.2 | 6.5 |
| I | 1.8 | 3.5 | 5.3 | 8.8 | 12.4 | 15.9 | 19.4 | 23.0 | 26.5 | 30.0 | 33.6 |
| J | 17.1 | 34.1 | 50.9 | 84.1 | 116.1 | 146.5 | 175.2 | 201.9 | 226.6 | 249.2 | 269.8 |
| K | 0.0 | 0.2 | 0.4 | 1.2 | 2.3 | 3.6 | 5.2 | 6.9 | 8.7 | 10.5 | 12.3 |
| L | 40.0 | 39.8 | 39.6 | 38.8 | 37.7 | 36.4 | 34.8 | 33.1 | 31.3 | 29.5 | 27.7 |

### Example 4

A graph from this example is illustrated in FIG. 4. In this example, there is one hole in the bottom layer (250) of the cavity room (200) with a diameter of 12 mm and a plurality of holes in the air-permeable part above this cavity room (200) (see TABLE 4) have a diameter of 2 mm. The ratio of the equivalent area of the hole(s) in the bottom layer (250) versus a hole in the air-permeable part is 6.00:1.

TABLE 4
(example 4)

| | | | | | | | | | | | |
|---|---|---|---|---|---|---|---|---|---|---|---|
| A | 1.2 | | | | | | | | | | |
| B | 40 | | | | | | | | | | |
| C | 12 | | | | | | | | | | |
| D | 1 | | | | | | | | | | |
| E | 12.0 | | | | | | | | | | |
| F | 2 | | | | | | | | | | |
| G | 1 | 2 | 5 | 10 | 15 | 20 | 25 | 30 | 35 | 40 | 45 |
| H | 2.0 | 2.8 | 4.5 | 6.3 | 7.7 | 8.9 | 10.0 | 11.0 | 11.8 | 12.6 | 13.4 |
| I | 3.1 | 6.3 | 15.7 | 31.4 | 47.1 | 62.8 | 78.5 | 94.2 | 110.0 | 125.7 | 141.4 |
| J | 30.3 | 60.6 | 150.3 | 292.5 | 420.3 | 530.8 | 623.4 | 699.6 | 761.8 | 812.3 | 853.4 |
| K | 0.0 | 0.1 | 0.8 | 2.9 | 5.9 | 9.4 | 13.0 | 16.4 | 19.4 | 22.1 | 24.4 |
| L | 40.0 | 39.9 | 39.2 | 37.1 | 34.1 | 30.6 | 27.0 | 23.6 | 20.6 | 17.9 | 15.6 |

### Example 5

A graph from this example is illustrated in FIG. 5. In this example, there is one hole in the bottom layer (250) of the cavity room (200) with a diameter of 4 mm and a plurality of holes in the air-permeable part above this cavity room (200) (see TABLE 5) have a diameter of 2 mm. The ratio of the equivalent area of the hole(s) in the bottom layer (250) versus a hole in the air-permeable part is 2:1.

TABLE 5
(example 5)

| | | | | | | | | | | | |
|---|---|---|---|---|---|---|---|---|---|---|---|
| A | 1.2 | | | | | | | | | | |
| B | 40 | | | | | | | | | | |
| C | 4 | | | | | | | | | | |
| D | 1 | | | | | | | | | | |
| E | 4.0 | | | | | | | | | | |
| F | 2 | | | | | | | | | | |
| G | 1 | 2 | 3 | 4 | 5 | 6 | 7 | 8 | 9 | 10 | 11 |
| H | 2.0 | 2.8 | 3.5 | 4.0 | 4.5 | 4.9 | 5.3 | 5.7 | 6.0 | 6.3 | 6.6 |
| I | 3.1 | 6.3 | 9.4 | 12.6 | 15.7 | 18.8 | 22.0 | 25.1 | 28.3 | 31.4 | 34.6 |
| J | 29.5 | 54.3 | 72.9 | 85.9 | 94.8 | 101.0 | 105.4 | 108.6 | 111.0 | 112.7 | 114.1 |
| K | 2.4 | 8.0 | 14.4 | 20.0 | 24.4 | 27.7 | 30.2 | 32.0 | 33.4 | 34.5 | 35.3 |
| L | 37.6 | 32.0 | 25.6 | 20.0 | 15.6 | 12.3 | 9.8 | 8.0 | 6.6 | 5.5 | 4.7 |

The theoretical calculated ‘optimum’ of example 1 is 15, of example 2 is 16, of example 3 is 29, of example 4 is 35 and of example 5 is 4.

Let us consider, for a good interpretation of FIG. 2 according example 2, that the total number of holes in the air-permeable part is 25, than the difference between pressure drop of open and closed holes is small. If no print-media (300) is supported on the air-permeable part, so all holes are open, the pressure difference is +/−11 mbar. If half of the holes in the air-permeable part is covered by print-media, which is 50% closed holes, than the pressure difference is +/−24 mbar. If all holes are covered by a print-media, thus 100% closed holes, than the pressure difference is 40 mbar.

To support the theory as described above the following test (TEST 2.1) is performed similar as example 2:
Cavity room: the shape is a rhombus wherein the diagonals are 89.5 mm and 128 mm, the depth of the cavity room is 6 mm. There is one circular shaped air-channel in the middle of the bottom layer with a diameter of 6 mm.
Air-permeable part: 25 circular shaped air-channels in the air-permeable part which all have a diameter of 1.5 mm. Each air-channel from the air-permeable part is numbered. Vertical distance between neighbouring air-channels is 30 mm and the horizontal distance between neighbouring air-channels is 15 mm. The air-permeable part is a part of a Forbo™ belt 6646-2.15E Black.

Several vacuum set points are tested: 40 mbar (graph H1), 30 mbar (graph H2), 20 mbar (graph H3) and 10 mbar (graph H4).

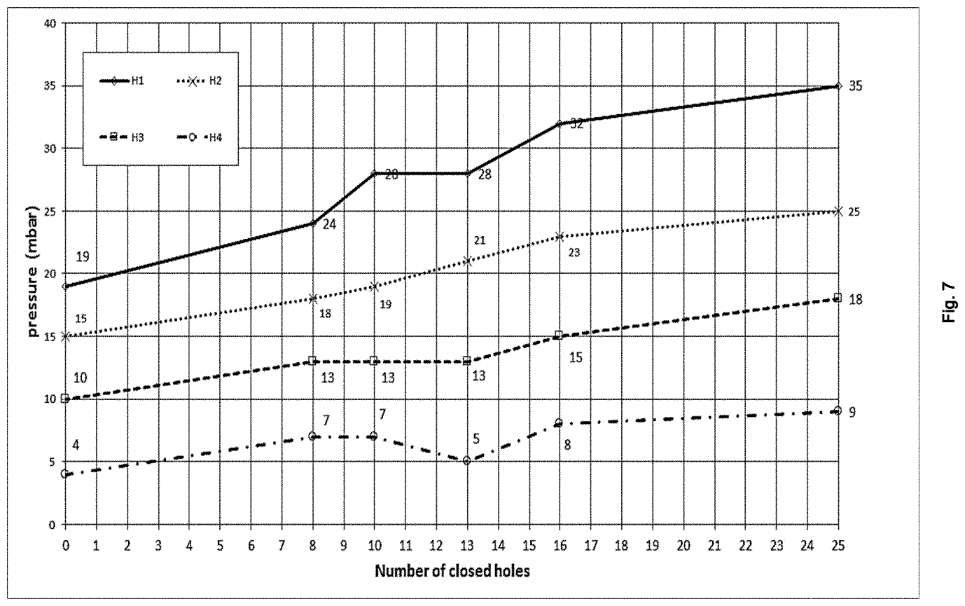

By closing each time one air-channel on the air-permeable part more until all are closed and measuring the pressure in one of the open remaining air-channels, the following graph as illustrated in FIG. 7 (FIG. 7) was measured. The number above a measurement point is the number of an open-remaining air-channel where the pressure is measured. Such measurement is done by a digital vacuum and pressure gauge from Becker™. The non-straight, but nearly linear, lines is explained that the pressure above open remaining air-channels, with the same closed air-channels, is not always the same. It is found that if all air-channels are covered (=closed) the vacuum set point is never reached.

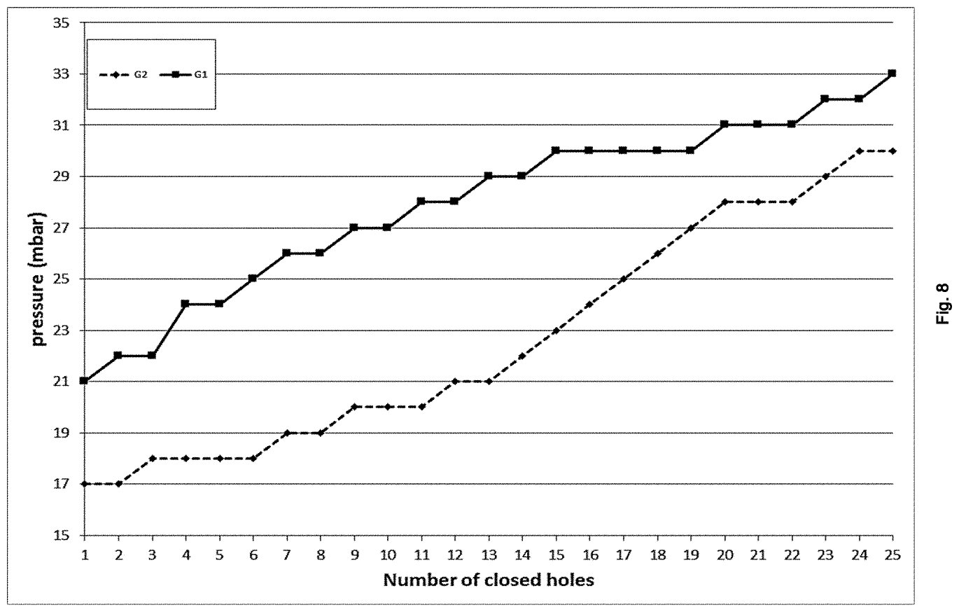

Another test (TEST 2.2) is performed at a vacuum set point of 40 mbar. The main cavity room in this test is surrounded with similar shaped cavity rooms, called neighbouring cavity rooms, which are each of them covered by an air-permeable part with the same specs as in the performed TEST 2.1. The main cavity room and neighbouring cavity rooms are connected to the same vacuum source. All air-permeable parts belongs to the same belt a Forbo™ belt 6646-2.15E Black. The pressure is measured at a certain open air-channel (number 13) from the main cavity room and one after the other air-channel from the main cavity room is closed so the following graph as illustrated in FIG. 8 (FIG. 8) was measured. One graph (G1) is the result of measurements when all the air-channels from the neighbouring cavity rooms are closed and one graph (G2) is the result of measurements when the air-channels from the neighbouring cavity rooms are open. This test shows that there is a pressure leak from one cavity to the other. It is found that there is a pressure leak from one cavity room to other neighbouring cavities, if they are all connected to the same vacuum source. This means the suction force in a vacuum zone, caused by a cavity room is influenced by the pressure of a neighbouring cavity room.

There are of course other constraints which have to be taken into account to optimize the present invention even more:
To ensure a certain stiffness of the air-permeable part and air-permeable media-support-layer (100) the positions of the air-channels comprises in them are preferably uniform distributed. The space (230) between these air-channels have to be large enough to be a support for the print-media (300) and to be able to carry the print-media.
The size and area of the air-channels are rather small else, the print-media (300) supported on the air-permeable part may deform by the suction force but also not that small because punching small air-channels is difficult to achieve and may also contaminated faster with dust and ink-debris.
The presence of a ceiling and/or filter, comprised in a cavity room, as prescribed in previous preferred embodiments, influences also the optimum because they interfere as resistor of the air-flow inside the cavity room (200).

Nevertheless, it is the principle of the cavity rooms and cascading of air-channels which is an enormous advantage for a printer manufacturer (cost-effectiveness) and a printer operator (lower production cost).

1-10. (canceled)

11: An inkjet printer comprising:
a vacuum table;
an air-permeable media-support-layer positioned on top of the vacuum table; wherein
the vacuum table includes a plurality of cavity rooms connected to a vacuum source and defines a plurality of vacuum zones on the air-permeable media-support-layer;
each of the plurality of cavity rooms is closed by an air-permeable portion of the air-permeable media-support-layer to define a vacuum zone among the plurality of vacuum zones;
each of the plurality of cavity rooms includes:
a space defined by a plurality of walls; and
a bottom layer including a first group of air-channels;
a ratio of width to length of a minimum bounding box of an area defined by the plurality of walls is between 1:1 and 2:5;
each of the air-permeable portions includes a second group of air-channels, and a sum of areas of the second group of air-channels is equal to or larger than a sum of areas of the first group of air-channels; and
the sum of areas of the first group of air-channels is smaller than a sum of areas of all air-channels that connect the first group of air-channels with the vacuum source.

12: The inkjet printer according to claim 11, wherein a ratio between an equivalent diameter of each of the second group of air-channels to an equivalent diameter of the first group of air-channels is between 0.50 and 0.166.

13: The inkjet printer according to claim 11, wherein a volume of the space defined by the plurality of walls is between 1 mm³ and 8,000,000 mm³.

14: The inkjet printer according to claim 13, wherein an angle between a media-transport direction of the air-permeable media-support-layer and a wall among the plurality of walls and/or between a printhead-movement-direction and a wall among the plurality of walls is between 5 and 85 degrees.

15: The inkjet printer according to claim 14, wherein the air-permeable media-support-layer includes a vacuum belt.

16: The inkjet printer according to claim 15, wherein each of the plurality of cavity rooms includes an air-permeable ceiling that supports the air-permeable portion of the air-permeable media-support-layer.

17: The inkjet printer according to claim 16, wherein the bottom layer and/or the plurality of walls are made of an engineering plastic composition, polyethylene terephthalate (PET), polyamide (PA), high-density polyethylene (HDPE), polytetrafluoroethylene (PTFE), polyoxymethylene (POM), and/or polyaryletherketone (PAEK).

18: The inkjet printer according to claim 17, wherein the plurality of walls are rounded at a contact zone with the air-permeable media-support-layer.

19: The inkjet printer according to claim 11, further comprising:
a second cavity room that includes a second bottom layer including a third group of air-channels; wherein
the bottom layer of a cavity room from among the plurality of cavity rooms defines a top layer of the second cavity room;
the sum of areas of the first group of air-channels is equal to or larger than a sum of areas of the third group of air-channels; and
the sum of areas of the third group of air-channels is smaller than the sum of areas of all air-channels that connects the third group of air-channels with the vacuum-source.

20: The inkjet printer according to claim 16, wherein the vacuum belt includes a carcass and a cover, and the carcass includes a woven fabric web and/or the cover is made of a thermoplastic polymer resin.

21: The inkjet printer according to claim 16, wherein the vacuum belt is sticky or includes synthetic setae that hold an inkjet receiver on top of the vacuum belt.

22: The inkjet printer according to claim 16, wherein the vacuum belt is movable by a belt step conveyor system.

23: The inkjet printer according to claim 11, wherein the inkjet printer is a corrugated fiberboard inkjet printer and includes a hot printing area and/or a curing area.

24: A method of using the inkjet printer according to claim 11 comprising:
printing on textiles, leather, corrugated fiberboard, or plastic foil with the inkjet printer.
